(19) United States
(12) Patent Application Publication
(10) Pub. No.: US 2026/0268642 A1
(43) Pub. Date: Sep. 10, 2026

(54) INFORMATION PROCESSING APPARATUS, TRAINING METHOD, IMAGE PROCESSING METHOD, AND MEDIUM

(71) Applicant: CANON KABUSHIKI KAISHA, Tokyo (JP)

(72) Inventors: JUNYA UCHIDA, Kanagawa (JP); YASUHARU HIRADO, Tokyo (JP)

(21) Appl. No.: 19/557,939

(22) Filed: Mar. 5, 2026

(30) Foreign Application Priority Data
Mar. 7, 2025 (JP) 2025-036696

(51) Int. Cl. G06V 10/774; G06T 5/60; G06V 10/776

(52) U.S. Cl. CPC G06V 10/774; G06T 5/60; G06V 10/776

(57) ABSTRACT

An information processing apparatus for training a machine learning model is provided. The apparatus acquires a ground truth (GT) image for use as GT data for training of the machine learning model that performs image enhancement processing for an image that has undergone preprocessing. The apparatus generates an input image that is used as input data for training of the machine learning model by performing processing associated with the preprocessing and inverse processing of the image enhancement processing on the GT image. The apparatus updates a parameter of the machine learning model stored in the one or more memories based on the input image and the GT image.

### BACKGROUND

### Field of the Technology

The present disclosure relates to an information processing apparatus, a training method, an image processing method, and a medium, and particularly relates to image enhancement processing for images.

### Description of the Related Art

Image enhancement processing for images is known. Known image enhancement processing techniques include noise removal processing, color interpolation (demosaicing) processing, aberration correction processing, super-resolution processing, and fog and haze removal processing. Such image enhancement processing can reduce or eliminate image degradation.

Michael (Michael Gharbi et al. “Deep Joint Demosaicking and Denoising”, SiGGRAPH Asia 2016) discloses that using a machine learning model for image enhancement processing improves image enhancement performance compared to conventional rule-based methods. A deep neural network is used as the machine learning model. According to Michael, various images collected on the web are used for training. Additionally, according to Michael, the training data is augmented by applying 90° rotations, horizontal flips, or 1-pixel shifts to the images.

### SUMMARY

According to an embodiment, an information processing apparatus for training a machine learning model comprises one or more memories storing instructions and one or more processors that execute the instructions to acquire a ground truth (GT) image for use as GT data for training of the machine learning model that performs image enhancement processing for an image that has undergone preprocessing, generate an input image that is used as input data for training of the machine learning model by performing processing associated with the preprocessing and inverse processing of the image enhancement processing on the GT image; and update a parameter of the machine learning model stored in the one or more memories based on the input image and the GT image.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a diagram showing an example of a hardware configuration of a training apparatus according to an embodiment.

FIG. 2 is a diagram showing an example of a functional configuration of the training apparatus according to an embodiment.

FIG. 3 is a diagram showing an example of a functional configuration of an image generation unit 300 according to an embodiment.

FIG. 4 is a diagram illustrating a procedure of generating a mosaic image.

FIG. 5 is a flowchart of a training method according to an embodiment.

FIG. 6 is a flowchart showing details of image correction processing according to an embodiment.

FIG. 7 is a diagram showing an example of a hardware configuration of an inference apparatus according to an embodiment.

FIG. 8 is a diagram showing an example of a functional configuration of the inference apparatus according to an embodiment.

FIG. 9 is a diagram illustrating results of bicubic interpolation.

FIG. 10 is a flowchart showing details of image correction processing according to an embodiment.

FIG. 11 is a diagram showing examples of variation patterns.

FIGS. 12A and 12B are diagrams illustrating parameters of image enhancement processing that correspond to respective image capturing lenses.

FIG. 13 is a diagram showing an example of a functional configuration of the image generation unit 300 according to an embodiment.

FIG. 14 is a diagram illustrating demosaicing processing.

FIGS. 15A to 15D are diagrams showing results of the image enhancement processing.

### DESCRIPTION OF THE EMBODIMENTS

Preprocessing may be performed prior to image enhancement processing. Preprocessing occurs during shooting or development any may include aberration correction and may be performed prior to demosaicing processing, which is performed as image enhancement processing. The inventors of the present application discovered that when image enhancement processing using a machine learning model is applied to an image that has undergone such preprocessing, image artifacts tend to occur, resulting in insufficient improvement in image quality.

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

An information processing apparatus according to an embodiment of the present disclosure trains parameters of a machine learning model for use in image enhancement processing (sometimes referred to as inference in this specification) to be applied to a preprocessed image. The following describes the case where demosaicing processing is used as the image enhancement processing. In this case, the preprocessed image is a mosaic image corresponding to, for example, a color filter array. The following also describes the case where aberration correction processing is performed as the preprocessing.

### Example of Configuration of Training Apparatus

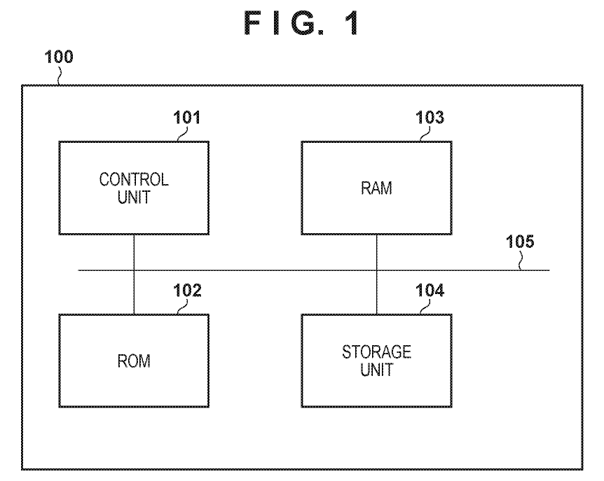

FIG. 1 shows an information processing apparatus according to an embodiment. The information processing apparatus according to an embodiment can be implemented by a computer that includes one or more processors and one or more memories. An example of a hardware configuration of a training apparatus 100 is shown. As shown in FIG. 1, the training apparatus 100 includes a control unit 101, a ROM 102, a RAM 103, and a storage unit 104.

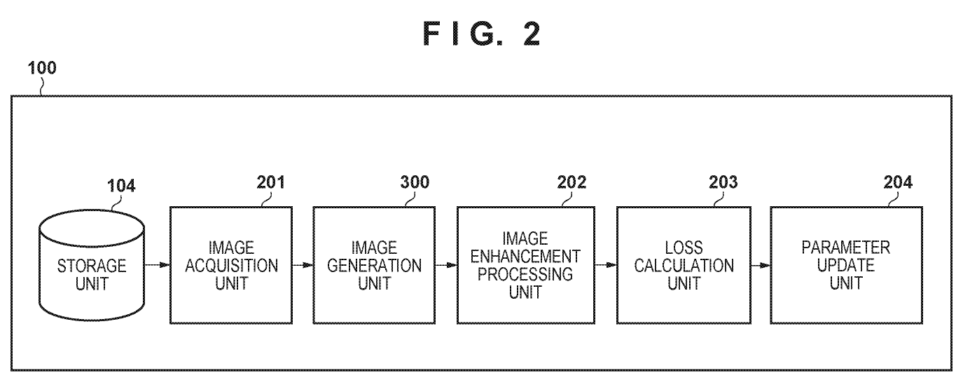

The control unit 101 is a processor such as a central processing unit. The control unit 101 performs calculations, logical judgments, and the like for various types of processing. Furthermore, the control unit 101 controls each constituent component connected to a system bus 105. The read-only memory (ROM) 102 is a program memory. The ROM 102 stores control programs including later-described various processing procedures that are performed by the control unit 101. The random access memory (RAM) 103 is a temporary storage memory. The RAM 103 is used as the main memory or work area for the control unit 101. Note that a program memory may be implemented by an external storage device or the like connected to the training apparatus 100. In this case, the control unit 101 can load programs from the external storage device into the RAM 103. Thus, a processor such as the control unit 101 can realize the functions of the later-described constituent components shown in FIG. 2 and the like by executing programs stored in the memory such as the ROM 102, RAM 103, or storage unit 104.

The storage unit 104 is an external storage device. The storage unit 104 can store electronic data or programs that are used in this embodiment. The external storage device may be, for example, a combination of a medium (recording medium) and an external storage drive for realizing an access to this medium. Known examples of such a medium include HDD, SSD, a flexible disk (FD), CD-ROM, DVD, a USB memory, MO, and a flash memory. Furthermore, the external storage device may also be a server device or the like that is connected via a network.

FIG. 2 is a diagram showing a functional configuration of the training apparatus 100 according to an embodiment. The training apparatus 100 includes an image acquisition unit 201, an image generation unit 300, an image enhancement processing unit 202, a loss calculation unit 203, and a parameter update unit 204. The functions of the training apparatus 100 shown in FIG. 2 can be implemented by a computer, but some or all of the functions of the training apparatus 100 may also be implemented by dedicated hardware. Furthermore, the information processing apparatus according to an embodiment of the present disclosure may be constituted by a plurality of information processing apparatuses connected via a network, for example.

In this embodiment, the storage unit 104 stores a ground truth (GT) image used as GT data for training. This GT image is used as the ground truth for a machine learning model within a framework of supervised learning. In this embodiment, the storage unit 104 stores a three-channel RGB image that is used as a GT image for demosaicing processing.

The image acquisition unit 201 acquires the GT image from the storage unit 104.

The image generation unit 300 generates an input image to be used as input data for training using the GT image acquired by the image acquisition unit 201. The image generation unit 300 can generate such an input image by performing the inverse processing of image enhancement processing. The inverse processing of image enhancement processing corresponds to processing of generating an image before being input to the image enhancement processing based on an image output by the image enhancement processing. The inverse processing of image enhancement processing is processing for generating input data from GT data for training. In this embodiment, a machine learning model for demosaicing processing (inference processing) is trained. The inverse processing of demosaicing processing is mosaicing processing. Therefore, the image generation unit 300 generates an input image using mosaic image generation processing.

At the same time, the image generation unit 300 generates such an input image by performing processing associated with preprocessing to be performed during inference, in addition to the inverse processing of image enhancement processing. This processing associated with preprocessing to be performed during inference may be processing that mimics the preprocessing. For example, this processing associated with preprocessing enables generating an input image that mimics an image obtained through the preprocessing. The processing that mimics the preprocessing may be the same type of processing as the preprocessing, but is not limited to the same type of processing. The processing associated with preprocessing may be processing that introduces image characteristics that occur due to the preprocessing. The processing associated with preprocessing may also be processing that introduces image artifacts (such as slight blurring, positional or size shifts between channels, and overshoot/undershoot) that tend to appear in a preprocessed image. Examples of the processing associated with preprocessing will be described in detail below. In the present specification, the processing associated with preprocessing is sometimes referred to as image correction processing.

In this embodiment, demosaicing processing is performed as the image enhancement processing on an image that has undergone aberration correction processing as the preprocessing. Therefore, the image generation unit 300 performs processing associated with aberration correction and mosaic image generation processing on the GT image to generate an input image.

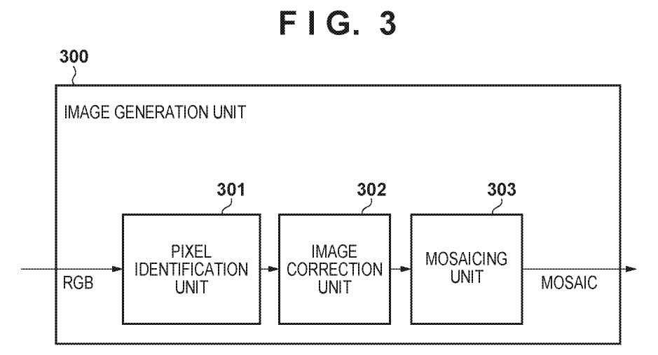

FIG. 3 is a diagram showing an example of a functional configuration of the image generation unit 300 according to this embodiment. The image generation unit 300 includes a pixel identification unit 301, an image correction unit 302, and a mosaicing unit 303.

The pixel identification unit 301 identifies the areas to which image correction processing is to be applied. For example, the pixel identification unit 301 can identify pixels to be affected by preprocessing during inference. In an embodiment, the pixel identification unit 301 can identify a specific color channel as the area to which image correction processing is to be applied. Furthermore, in an embodiment, the pixel identification unit 301 can identify the areas to which image correction processing is to be applied based on local contrast in the GT image. The pixel identification unit 301 may identify pixels where specific image characteristics are likely to appear due to preprocessing during inference. The pixel identification unit 301 may also identify areas where the amount of image variation due to preprocessing is large. The target areas for image correction processing may be determined in advance based on the type of processing. The specific method for identifying the target areas will be described later.

The image correction unit 302 performs image correction processing on the areas identified by the pixel identification unit 301. The image generation unit 300 can generate an image that mimics the image to be generated by the preprocessing during inference.

The mosaicing unit 303 performs mosaicing processing on the image processed by the image correction unit 302. In this embodiment, the image correction unit 302 outputs a three-channel RGB image. Based on this image, the mosaicing unit 303 generates a mosaic image according to a color filter array.

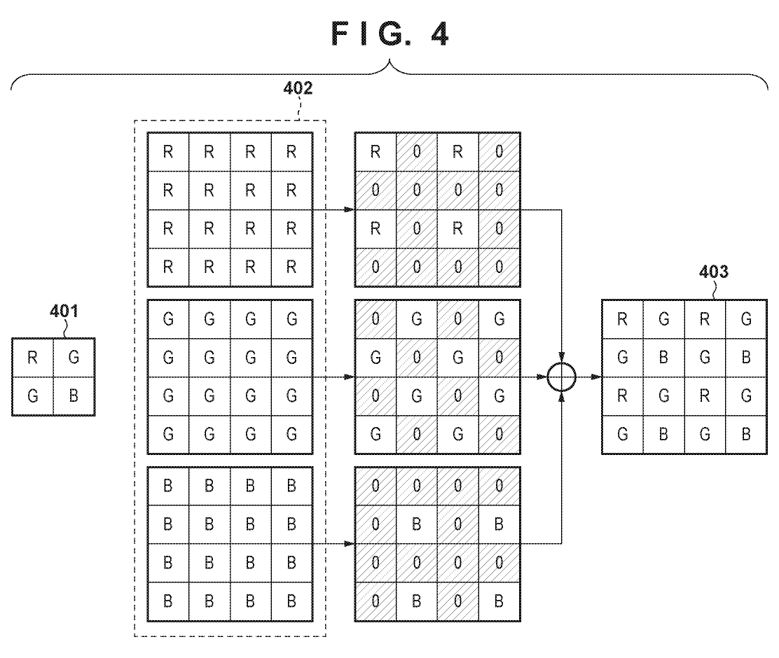

FIG. 4 is a diagram illustrating a procedure of generating a mosaic image 403 according to a Bayer pattern color filter array 401 based on a three-channel RGB image 402. The image 402 is output by the image correction unit 302. The processing for 2×2 pixels at an upper left end of the image 402 is as follows. The mosaicing unit 303 extracts pixels based on the color filter array 401: the upper left pixel of the 2×2 pixels from the R channel, the upper right and lower left pixels of the 2×2 pixels from the G channel, and the lower right pixel of the 2×2 pixels from the B channel. At this time, other pixels are discarded. The mosaicing unit 303 performs this operation on all the pixels of the image 402 at equal intervals. Finally, the mosaicing unit 303 generates the single-channel mosaic image 403 by obtaining the sum of the elements of the extracted three-channel images.

The image enhancement processing unit 202 performs image enhancement processing on an input image. The image enhancement processing unit 202 performs image enhancement processing on the input image using a machine learning model to generate an output image. With this processing, an image with higher image quality than the input image is output. A neural network using deep learning, or the like can be used as the machine learning model. For example, a convolutional neural network (CNN) as used in Michael can be used as the machine learning model. Additionally, a U-Net, a generative adversarial network, a transformer, or the like may also be used as the machine learning model. Furthermore, the machine learning model may include a convolution and a nonlinear transformation such as a rectified linear unit (hereinafter ReLU). However, the type of nonlinear transformation is not specifically limited. Moreover, the configuration of the machine learning model is not limited to the above-described examples.

As described above, in this embodiment, demosaicing processing is performed as the image enhancement processing. The input image to the machine learning model is a single-channel mosaic image. This mosaic image is a mosaic image according to a Bayer pattern. Furthermore, the output image from the machine learning model is a three-channel RGB image.

The loss calculation unit 203 calculates inference loss of the inference performed by the image enhancement processing unit 202. The loss calculation unit 203 can calculate the loss for the output image based on the error between the GT image acquired by the image acquisition unit 201 and the output image output by the image enhancement processing unit 202. The loss calculation unit 203 can calculate the loss using the mean absolute error or mean squared error between the output image and the GT image. However, the type of loss is not limited to these.

The parameter update unit 204 updates one or more parameters of the machine learning model used by the image enhancement processing unit 202. The parameter update unit 204 updates the parameters of the machine learning model based on the input image and the GT image. More specifically, the parameter update unit 204 can update the parameters based on the loss that corresponds to the set of input image and GT image and is calculated by the loss calculation unit 203. That is, the parameter update unit 204 can update the parameters based on the error between the output image and the GT image. The error backpropagation method can be used for the parameter update. Furthermore, the parameter update unit 204 may use optimization techniques such as the gradient descent method. However, the parameter update method is not limited to these methods.

### Example of Processing of Training Apparatus

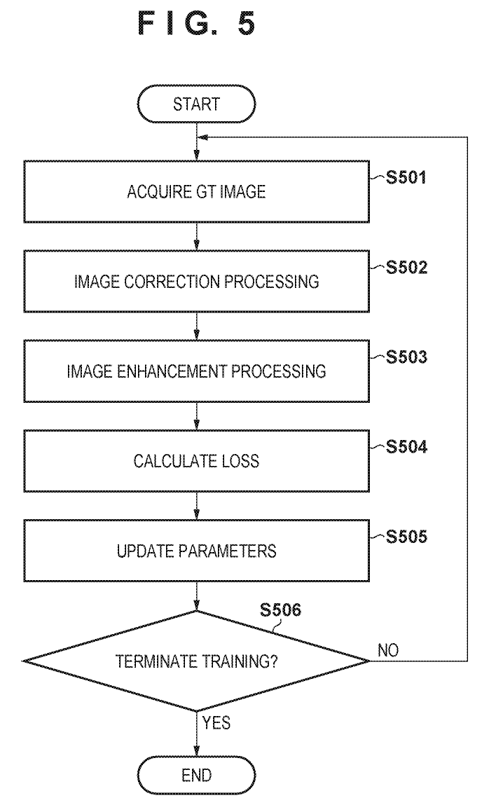

FIG. 5 is a flowchart of a training method performed by the training apparatus 100 according to this embodiment.

In step S501, the image acquisition unit 201 acquires a GT image stored in the storage unit 104. In this embodiment, the GT image is a three-channel RGB image.

In step S502, the image generation unit 300 performs image correction processing on the GT image acquired in step S501. As described above, the image correction processing may be processing that mimics preprocessing. In this embodiment, aberration correction is performed as the preprocessing. Typically, in aberration correction, warping processing is performed on an image where a geometric shape appears distorted due to optical characteristics, so that it matches the actual geometric shape. That is, a change is made to the geometric shape in an aberration-corrected image. Taking into consideration such characteristics, in this embodiment, the image generation unit 300 performs processing for changing the geometric shape of the GT image, as the processing that mimics aberration correction. For example, the image generation unit 300 can perform geometric transformation processing such as shift processing or scaling processing. Additionally, aberration correction may cause image blurring. Therefore, the image generation unit 300 may perform blurring processing using a smoothing filter, Gaussian filter, or the like, as the processing that mimics aberration correction. Alternatively, as the processing that mimics aberration correction, aberration correction of a predetermined or randomly determined strength may be performed.

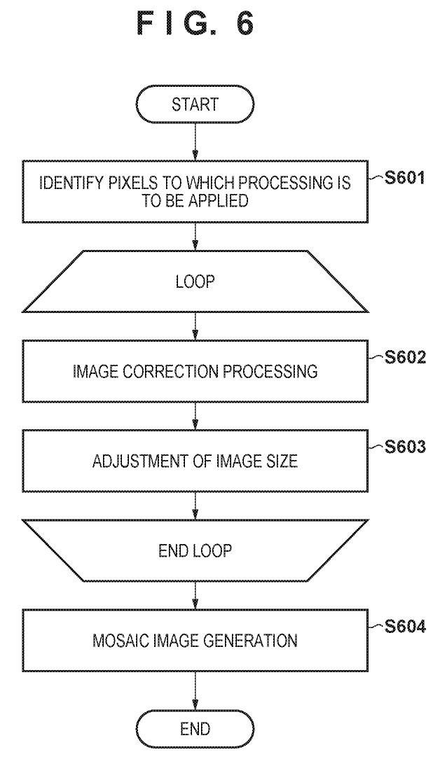

FIG. 6 is a flowchart showing details of the processing in step S502. In step S601, the pixel identification unit 301 identifies the pixels to which image correction processing is to be applied. In one embodiment, in aberration correction which is preprocessing to be performed during inference, processes using different variable parameters are respectively performed on the mosaiced R-channel image and the mosaiced B-channel image to align them with the G-channel image. In one embodiment, the preprocessing is lateral chromatic aberration correction processing, and such processing is performed. In this case, the pixels that may be affected by the preprocessing during inference can be all pixels in the R and B channels. Therefore, the pixel identification unit 301 can identify all the pixels in the R and B channels as processing target pixels. In this manner, image correction processing can be performed selectively on the R channel and the B channel. In this embodiment, the processes in steps S602 and S603 are performed sequentially for each of the R-channel image and the B-channel image.

In step S602, the image correction unit 302 performs image correction processing on the pixels identified by the pixel identification unit 301. In this embodiment, the image correction unit 302 performs either geometric transformation processing or blurring processing on each of the R channel and the B channel. The image correction unit 302 can perform image correction processing based on a randomly determined variable parameter or predetermined certain variable parameter. The variable parameter is a parameter for the image correction processing. The variable parameter can indicate the processing strength. For example, the processing strength may be the shift amount of shift processing, the enlargement or reduction amount of scaling processing, or the strength of blur processing. Furthermore, the variable parameter may represent the shift direction of shift processing or the transformation matrix of geometric transformation processing.

In one embodiment, the image correction unit 302 can determine a variable parameter according to a predetermined variation pattern. A variation pattern can indicate a range for a variable parameter. For example, a variation pattern may indicate that the shift amount for the shift processing is between 0.0 and 2.0 pixels. In this case, the image correction unit 302 can randomly determine the variable parameter within the range indicated by the variation pattern.

The image correction unit 302 may perform processes according to different variable parameters on the R channel and the B channel, respectively. For example, geometric transformation processing in different directions, or processing with different strengths may be performed on the R channel and the B channel, respectively.

The image correction unit 302 may perform image correction processing such that the processing performed on the image edge is stronger than the processing performed on the image center. When enlarging or reducing an image during aberration correction processing, the amount of displacement of pixels located at the image edge becomes larger than the amount of displacement of pixels located at the image center. In order to reproduce the results of such aberration correction processing across the entire image and individual portions of the image, the processing strength at the image edge can be made greater than the processing strength at the image center.

In S603, the image correction unit 302 adjusts the size of the image obtained in step S602. The image correction unit 302 can perform adjustment such that the size of the image after the processing in step S602 is the same as the size of the image before the processing in step S602. For example, if the image size becomes larger than the original size, the image correction unit 302 can crop areas corresponding to the areas outside the original image. Furthermore, if the image size becomes smaller than the original size, the image correction unit 302 can perform padding on areas that are missing compared to the original image. For example, the image correction unit 302 can set the pixel values of the missing areas to zero. The image correction unit 302 can also copy the pixel values of the surrounding areas to the pixels of the missing areas.

In step S604, the mosaicing unit 303 converts the image obtained in step S603 into a mosaic image. The mosaic image generated by the mosaicing unit 303 is used as an input image for image enhancement processing.

In step S503, the image enhancement processing unit 202 performs image enhancement processing on the input image obtained in step S502. In this embodiment, a three-channel RGB image is generated by the image enhancement processing.

In step S504, the loss calculation unit 203 calculates the loss using the difference between the three-channel RGB image output in step S503 and the three-channel RGB image (GT image) acquired in step S501.

In step S505, the parameter update unit 204 updates the parameters of the image enhancement processing to be performed by the image enhancement processing unit 202, based on the loss calculated in step S504.

In step S506, the parameter update unit 204 determines whether to terminate the training. When the loss value obtained by the loss calculation unit 203 is smaller than a predetermined threshold, the parameter update unit 204 can determine to terminate the training. Furthermore, when training has been performed a predetermined number of times, the parameter update unit 204 can determine to terminate the training. Then, the parameter update unit 204 stores the parameters of the image enhancement processing obtained through the training in the storage unit 104.

Note that, in step S502, an additional input image can be generated by mosaicing the GT image through the processing in step S604, without performing the processing in steps S601 to S603. In steps S503 to S506, the image enhancement processing and the parameter update can be performed using such an input image. That is, the image correction unit 302 can generate an input image for use as input data for training as already described, by performing the image correction processing and the inverse processing of the image enhancement processing. Furthermore, the image correction unit 302 can generate an additional input image for use as input data for training, by performing the inverse of the image enhancement processing without performing the image correction processing. At this time, the parameter update unit 204 can update the parameters based on each of the input image and the additional input image, and on the GT image. In other words, the loss calculation unit 203 can calculate the inference loss for each of the input image and the additional input image. Furthermore, the parameter update unit 204 can update the parameters based on the loss for each of the input image and the additional input image. In this case, the input image corresponds to input data for training generated as augmentation data, in addition to the additional input image. Also, the input image and the additional input image may be mixed, and the parameters may be updated using the mixed data.

The image correction unit 302 may also generate a plurality of input images by performing image correction processing according to different parameters, respectively. For example, in step S602, the image correction unit 302 may generate a plurality of images by performing image correction processing using a plurality of different variable parameters on the single GT image acquired in step S501. For example, the image correction unit 302 may perform image correction processing with different strengths. In this case, a plurality of input images are generated in step S502. At this time, the parameter update unit 204 can update the parameters of the machine learning model based on each of the plurality of input images. That is, the loss calculation unit 203 can calculate the inference loss for each of the plurality of input images. Furthermore, the parameter update unit 204 can update the parameters based on the loss for each of the plurality of input images. According to this method, it is possible to create a larger number of pieces of input data for training corresponding to a single GT image, as augmentation data.

### Example of Configuration of Inference Apparatus

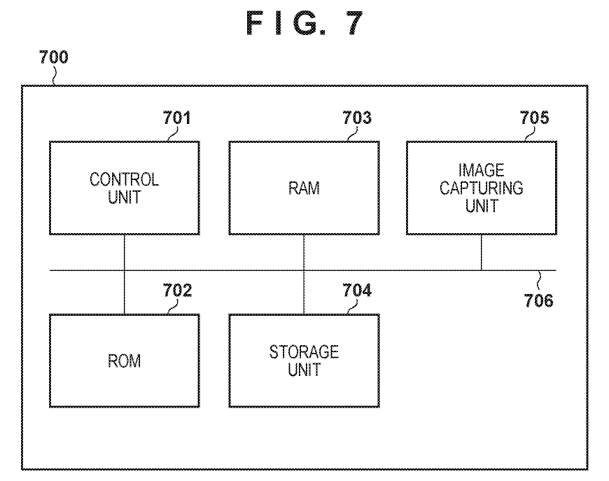

FIG. 7 is a diagram showing an example of a hardware configuration of an inference apparatus 700, which is the information processing apparatus according to an embodiment. In this embodiment, the inference apparatus 700 is a camera that includes an image capturing unit 705. As shown in FIG. 7, the inference apparatus 700 includes a control unit 701, a ROM 702, a RAM 703, a storage unit 704, the image capturing unit 705, and a system bus 706. The inference apparatus 700 may have a hardware configuration similar to that of the training apparatus 100, except that the inference apparatus 700 includes the image capturing unit 705. On the other hand, the inference apparatus 700 need not include the image capturing unit 705. For example, the inference apparatus 700 may be an apparatus that has the same configuration as that of the training apparatus 100. For example, the inference apparatus 700 may be a computing machine such as a personal computer or a cloud server. In this case, the inference apparatus 700 can acquire captured images from an external camera or an external information processing apparatus.

Furthermore, the storage unit 704 stores in advance parameters of image enhancement processing obtained by the training apparatus 100. On the other hand, the control unit 701 may acquire parameters of image enhancement processing from an external apparatus via a network or the like.

The image capturing unit 705 generates captured images. The image capturing unit 705 may include an imaging optical system, an image sensor, an A/D converter, an aperture control device, and a focus control device. The imaging optical system may include a fixed lens, a zoom lens, a focus lens, an aperture, and an aperture motor. In the present specification, the imaging optical system is sometimes referred to as an imaging lens. The image sensor converts the optical image of a subject into an electrical signal. The image sensor may be, for example, a CCD or CMOS. The A/D converter converts analog signals into digital signals. In the image capturing unit 705, a subject image is formed on the image forming plane of the image sensor by the imaging lens. The image sensor also converts the subject image into an electrical signal. Then, the A/D converter subjects the electrical signal to A/D conversion processing, thereby generating a captured image. The captured image is supplied to the RAM 703 or the storage unit 704.

The aperture control device controls the operation of the aperture motor to change the opening diameter of the aperture, thereby controlling the aperture of the imaging lens. The focus control device drives the focus lens to control the focus state of the imaging lens. The focus control device can control the operation of a focus motor based on the phase difference between a pair of focus detection signals obtained from the image sensor.

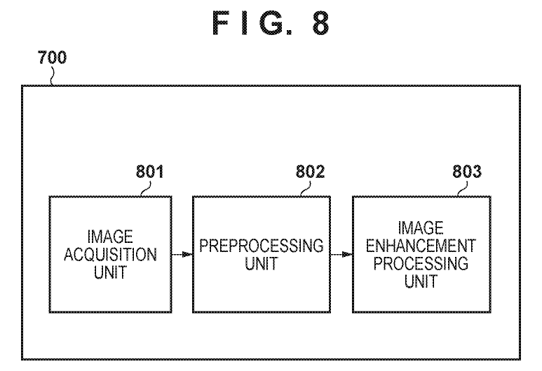

FIG. 8 is a diagram showing a functional configuration of the inference apparatus 700 according to an embodiment. The inference apparatus 700 includes an image acquisition unit 801, a preprocessing unit 802, and an image enhancement processing unit 803. Similar to the training apparatus 100, the functions of the inference apparatus 700 can be realized by programs, dedicated hardware, or a combination thereof.

The image acquisition unit 801 acquires a captured image to be subjected to image enhancement processing. The image acquisition unit 801 can acquire a captured image captured by the image capturing unit 705 using the imaging optical system. Furthermore, the image acquisition unit 801 may also acquire a captured image stored in the RAM 703 or the storage unit 704.

The preprocessing unit 802 performs preprocessing on the image acquired by the image acquisition unit 801. The preprocessing is associated with the above-described image correction processing. In this embodiment, the preprocessing unit 802 performs aberration correction as the preprocessing. That is to say, the preprocessing unit 802 performs processing for correcting distortion caused by the optical characteristics of the image capturing unit 705. The preprocessing unit 802 can perform preprocessing according to the imaging optical system. In this embodiment, the preprocessing unit 802 performs aberration correction for correcting aberrations caused by the optical characteristics specific to the imaging lens of the image capturing unit 705.

The image enhancement processing unit 803 performs image enhancement processing on the captured image that has undergone the preprocessing. The image enhancement processing unit 803 performs image enhancement processing using the parameters determined through training of the training apparatus 100. As described above, the training apparatus 100 can train parameters of a machine learning model. Then, the image enhancement processing unit 803 can perform image enhancement processing using the machine learning model obtained through the training.

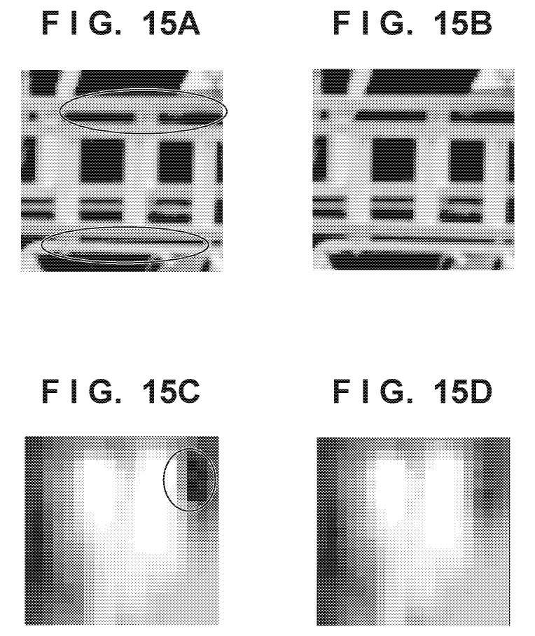

The training method according to this embodiment can improve the image quality obtained by the image enhancement processing performed after the preprocessing. FIG. 15B shows the result of image enhancement processing using a model trained by the method according to this embodiment. FIG. 15A shows the result of image enhancement processing using a model trained without performing the image correction processing (step S602). As indicated by the ellipses in FIG. 15A, zipper patterns are likely to occur in the image obtained through the preprocessing and the image enhancement processing. On the other hand, by augmenting training data through the image correction processing (step S602), the occurrence of zipper patterns in the image obtained through the preprocessing and the image enhancement processing is suppressed.

Also, in the method described by Michael, using the data augmentation technique, a variety of GT images for training with different rotation angles or the like can be generated from a single image collected on the web, and input images that correspond to the respective GT images can be generated. However, it is conceivable that no preprocessing is applied to the image collected on the web. Also, even if preprocessing is applied, it is conceivable that a different type or strength of preprocessing from that applied during inference is used. It is also conceivable that the image characteristics introduced by preprocessing are lost by post-processing of the image enhancement processing. Accordingly, it is conceivable that there is insufficient training to handle images that have been subjected to preprocessing and have the image characteristics introduced by the preprocessing. Therefore, when applying image enhancement processing using a machine learning model trained by a method as described in Michael to a preprocessed image, image quality may decrease.

In the above-described present embodiment, an input image for training is generated by performing image correction processing associated with preprocessing on a GT image. With such a configuration, it is possible to introduce the image characteristics resulting from the preprocessing into the input image. That is, the data characteristics of the input data for training can be made closer to the data characteristics of a captured image to which the image enhancement processing during inference is to be applied. Using an input image generated in this manner enables efficient training to correspond to an image having the image characteristics resulting from preprocessing. Accordingly, it is conceivable that the accuracy of the image enhancement processing for an image to which preprocessing was applied can be improved. Note that images collected on the web often lack information indicating parameters of preprocessing or information that was collected during shooting and can be referenced for preprocessing. However, according to the method of the present embodiment, it is possible to generate input images for training without using these pieces of information. Note that, in the image correction processing of the present embodiment, it is not necessary to precisely mimic preprocessing during inference. By using images having characteristics that may be introduced during preprocessing as an input image, it is possible to perform training suitable for image enhancement processing for an image to which preprocessing was applied. In one embodiment, by performing image correction processing using a variety of variable parameters (including e.g., randomly determined variable parameters or multiple variable parameters), input images can be obtained as augmentation data. By performing training using the input images obtained in this manner, it is possible to improve the accuracy of the image enhancement processing for images to which preprocessing with various strengths was applied.

### Modification of Image Correction Processing

The image generation unit 300 may reproduce patterns that occur due to preprocessing during inference, through image correction processing. That is, the image generation unit 300 can introduce such patterns into the GT image.

The following will describe a modification where aberration correction using bicubic interpolation is performed as preprocessing during inference. For example, when performing warping processing during aberration correction, the pixel value of each corrected pixel can be calculated through interpolation processing. Bicubic interpolation is a method of interpolating the pixel value of an interpolation target pixel using a cubic equation. In bicubic interpolation, an undershoot or overshoot may occur.

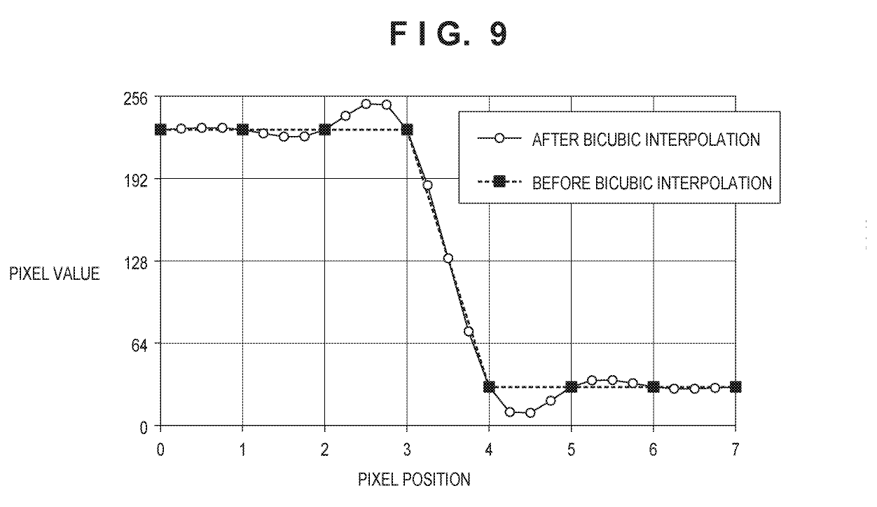

In bicubic interpolation, the pixel value of an interpolation target pixel can be calculated using surrounding 4×4 pixels of the interpolation target pixel. FIG. 9 shows the result of bicubic interpolation with a four-fold resolution that was performed on an image. In this image, a group of pixels of a pixel value 230 and a group of pixels of a pixel value 30 are arranged side by side in the one-dimensional direction. FIG. 9 shows the pixel value of a pixel at each pixel position before and after bicubic interpolation. In FIG. 9, the horizontal axis represents the pixel position. Also, the vertical axis represents the pixel value. FIG. 9 shows that between pixel positions 2 and 3, the pixel values after the bicubic interpolation deviate significantly beyond the pixel values before the bicubic interpolation. This is an overshoot caused by the bicubic interpolation. Similarly, between pixel positions 4 and 5, the pixel values after the interpolation deviate significantly below the pixel values before the interpolation. This is an undershoot. Furthermore, as shown in FIG. 9, such an undershoot and such an overshoot tend to occur in areas where there is a large difference in pixel values between adjacent pixels, i.e., in high-contrast areas.

Therefore, in this modification, the image generation unit 300 performs image correction processing that introduces an undershoot or overshoot into the GT image as a pattern that occurs due to the preprocessing during inference. Furthermore, the image generation unit 300 can identify the pixels to be subjected to image correction processing based on the contrast at each pixel position. The image generation unit 300 can then selectively perform pixel value correction processing on the high-contrast areas, as image correction processing. Thus, the image generation unit 300 can introduce an undershoot or overshoot to at least some of the identified pixels.

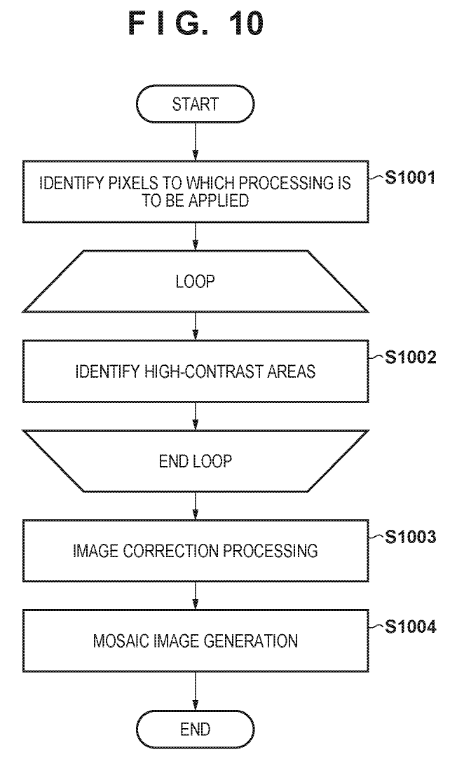

In this modification, the processing in step S502 can be performed in accordance with the flowchart shown in FIG. 10. In step S1001, the pixel identification unit 301 identifies the R-channel and B-channel images as targets to which the image correction processing is to be applied, similar to step S601. In this modification, the processing in step S1002 is performed on each of the R-channel image and the B-channel image, sequentially.

In step S1002, the pixel identification unit 301 further identifies high-contrast areas of each of the R-channel and B-channel images. As described above, in high-contrast areas, an undershoot or overshoot tends to occur due to preprocessing.

The pixel identification unit 301 can identify high-contrast areas with an edge detection method using a Sobel filter or the like, for example. Furthermore, the pixel identification unit 301 may determine that the contrast of an evaluation target pixel is high when the pixel values of the evaluation target pixel and its surrounding pixels satisfy predefined conditions. For example, the pixel identification unit 301 can evaluate the contrast based on the difference in pixel values between the evaluation target pixel and its surrounding pixels. When the evaluated contrast is higher than a threshold, the pixel identification unit 301 may determine that the contrast of the evaluation target pixel is high. Such a method may be used to identify a high-contrast area. The pixel identification unit 301 may also identify a surrounding area of a saturated area as a high-contrast area. Furthermore, the pixel identification unit 301 may calculate the product or sum of the high-contrast areas identified by a plurality of methods. The area calculated in this manner can be subjected to image correction processing.

In step S1003, the image correction unit 302 performs image correction processing on the pixels identified in step S1002. In this modification, the image correction unit 302 corrects at least some of the pixel values of the high-contrast pixels. The image correction unit 302 can correct only some of the pixel values of the pixels identified in step S1002. For example, the image correction unit 302 may randomly sample some of the pixels identified in step S1002. The image correction unit 302 may select a predetermined percentage of pixels or a predetermined number of pixels from all the pixels identified in step S1002. Such predetermined percentage and predetermined number may be defined in advance.

The image correction unit 302 can correct the pixel values of the pixels selected in this manner so that they represent an undershoot or overshoot. For example, the image correction unit 302 may update the pixel values of the selected pixels to pixel values calculated based on the pixel values of their surrounding pixels or statistical values of the pixel values. Furthermore, the image correction unit 302 may update the pixel values of the selected pixels to preset pixel values representing an undershoot or overshoot. Note that, when the pixel values of the selected pixels are greater than the average pixel value of their surrounding pixels, the image correction unit 302 may increase the pixel values so that they represent an overshoot. Furthermore, when the pixel values of the selected pixels are less than the average pixel value of their surrounding pixels, the image correction unit 302 may decrease the pixel values so that they represent an undershoot.

Processing in step S1004 is performed in the same manner as in step S604.

The training method according to this embodiment can improve the image quality obtained by the image enhancement processing performed after the preprocessing. FIG. 15D shows the result of image enhancement processing using a model trained by the method of this modification. FIG. 15C shows the result of image enhancement processing using a model trained without performing the image correction processing (step S1003). As indicated by the ellipse in FIG. 15C, an undershoot or overshoot may occur in the image obtained through the preprocessing and the image enhancement processing. On the other hand, by augmenting the training data through the image correction processing (step S1003), the occurrence of undershoot and overshoot in the image obtained through the preprocessing and the image enhancement processing is suppressed.

The frequency of undershoot or overshoot occurrence due to the preprocessing during inference may be low. However, if any undershoot or overshoot remains in the image obtained through the image enhancement processing, image quality will significantly deteriorate. According to this modification, patterns that mimic the patterns occurring due to the preprocessing during inference can be introduced into an input image for training while controlling the frequency of the occurrence. On the other hand, such patterns are not introduced into the GT image. Therefore, the parameters of the image enhancement processing are trained so that the image enhancement processing applied to an image having a pattern that occurs due to preprocessing yields an image that does not include such a pattern. Thus, by training the parameters of the image enhancement processing to address patterns occurring due to preprocessing during inference, the image quality obtained through the image enhancement processing can be improved.

### Training of Multiple Sets of Parameters

In one embodiment, the training apparatus 100 can train multiple sets of parameters of machine learning models. In this case, the inference apparatus 700 can perform image enhancement processing using parameters selected from the multiple sets of parameters. In other words, the inference apparatus 700 can perform image enhancement processing using a machine learning model selected from multiple machine learning models that respectively correspond to different parameters.

In particular, the inference apparatus 700 can select the image enhancement processing parameters that are suitable for preprocessing of image enhancement processing during inference. For example, the inference apparatus 700 can select the parameters corresponding to the strength of the preprocessing to be performed during inference, that is, the parameters corresponding to the amount of image variation caused by the preprocessing. To this purpose, the training apparatus 100 can generate a plurality of image enhancement processing parameters that respectively correspond to different amounts of variation.

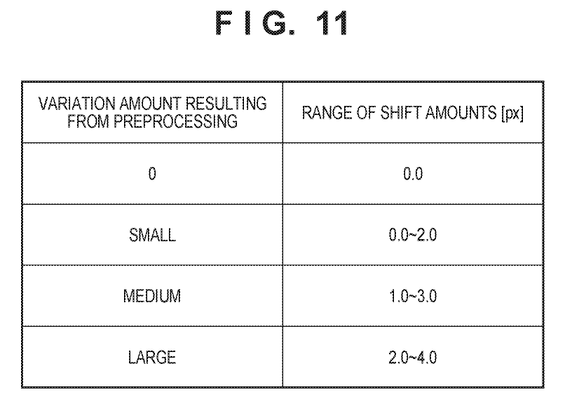

First, processing that is performed by the training apparatus 100 in this modification is described. In this modification, the image generation unit 300 can acquire a plurality of variation patterns. FIG. 11 shows a table that defines four variation patterns when performing shift processing as image correction processing. In FIG. 11, four ranges of shift amounts are defined as variation patterns. Furthermore, a variation amount of the image resulting from the preprocessing is associated with each variation pattern. In this example, as the variation amounts of the image resulting from the preprocessing that is performed by the inference apparatus 700, four variation amounts are assumed, namely, zero “0”, a small variation “small”, a medium variation “medium” between the small and large variations, and a large variation “large”. The range of a variable parameter such as a shift amount can be arbitrarily set in advance according to the variation amount of the image resulting from the preprocessing that may be performed by the inference apparatus 700. Note that, when performing enlargement or reduction processing, the range of enlargement or reduction magnifications can be set as a variation pattern. Also, when performing blur processing, the range of strength of the blur processing can be set as a variation pattern. In the example shown in FIG. 11, the ranges indicated by the respective variation patterns may have different sizes. On the other hand, the ranges indicated by the respective variation patterns may have the same size. In another example, the maximum or minimum values of the respective ranges indicated by the plurality of variation patterns may differ from each other. Furthermore, at least one of the plurality of variation patterns may indicate variable parameter values rather than a variable parameter range.

The image generation unit 300 generates an input image for training using one of the plurality of variation patterns. Furthermore, the image enhancement processing unit 202, the loss calculation unit 203, and the parameter update unit 204 update the parameters of the image enhancement processing based on the input image for training. By performing such training using each of the multiple variation patterns, multiple sets of image enhancement processing parameters can be obtained. Thus, the image generation unit 300 can generate a first input image by performing processing associated with the image correction processing with the strength determined from a first range and the inverse processing of the image enhancement processing on the GT image. Also, the image generation unit 300 can generate a second input image by performing the image correction processing with a strength determined from a second range, which is different from the first range, and the inverse processing of the image enhancement processing on the GT image. Furthermore, the parameter update unit 204 can create first parameters by updating the parameters of the machine learning model based on the first input image and the GT image. Furthermore, the parameter update unit 204 can create second parameters by updating the parameters of the machine learning model based on the second input image and the GT image. By preparing multiple sets of image enhancement processing parameters, it is possible to deal with variation amounts resulting from various types of preprocessing that is performed by the inference apparatus 700.

In another embodiment, the image generation unit 300 may set one or more variation patterns based on variation amounts resulting from preprocessing that is performed by the inference apparatus 700.

In this modification, the training apparatus 100 can generate multiple sets of machine learning model parameters, by performing processing in accordance with the flowchart shown in FIG. 5 based on each of different variation patterns. The following describes the case where four variation patterns are used, as shown in the example in FIG. 11. In this case, processing is performed four times, each using a different variation pattern selected from the four variation patterns. Thus, four sets of parameters are generated. The following describes the specific processing in this modification.

In S502, the image generation unit 300 performs image correction processing on the GT image according to the selected variation pattern. For example, as shown in FIG. 11, if the variation pattern corresponding to the variation amount “0” resulting from the preprocessing is selected, the image generation unit 300 does not perform a shift process. If the variation pattern corresponding to the variation amount “small” is selected, the image generation unit 300 randomly determines the shift amount from the range of 0.0 to 2.0 pixels. Then, the image generation unit 300 performs a shift process according to the determined shift amount. Similarly, when a variation pattern corresponding to the variation amount “medium” or “large” is selected, the image generation unit 300 can randomly determine the shift amount from the range corresponding to the variation pattern.

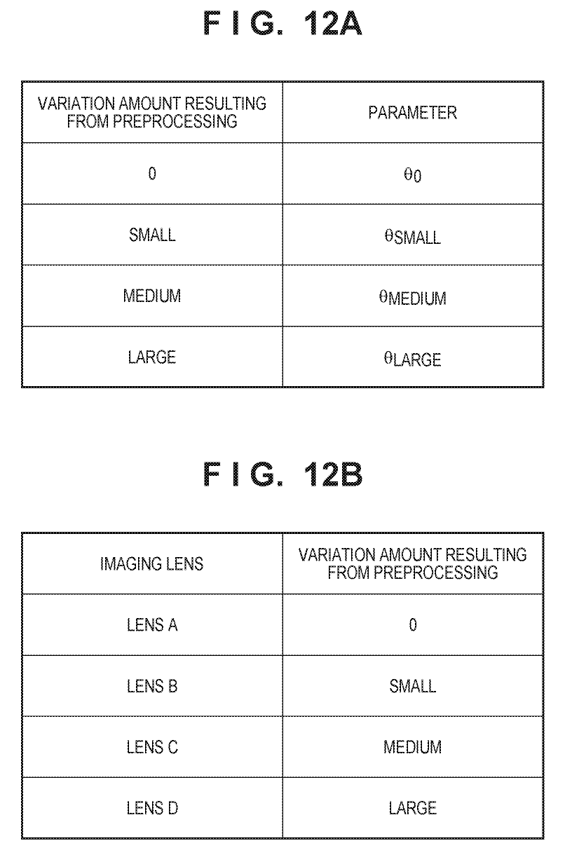

Thus, using the variation pattern corresponding to each of the preprocessing variation values “0”, “small”, “medium”, and “large”, the processing shown in FIG. 5 is performed. In this way, as shown in FIG. 12A, image enhancement processing parameters θ₀, θₛₘₐₗₗ, θ_{medium}, and θ_{large} that respectively correspond to the preprocessing variation values “0”, “small”, ‘medium’, and “large” are obtained.

Next, the specific processing performed by the inference apparatus 700 in this modification is described. In this modification, the inference apparatus 700 can use multiple sets of image enhancement processing parameters. Such multiple sets of parameters may be stored in advance in the storage unit 704. In this modification, the storage unit 704 stores the multiple sets of parameters in association with the preprocessing. For example, the storage unit 704 may store a table as shown in FIG. 12A. In this table, each set of parameters is associated with a variation amount of the image resulting from the preprocessing. Furthermore, the image enhancement processing unit 803 selects parameters corresponding to the preprocessing that is performed by the preprocessing unit 802, from among the multiple sets of image enhancement processing parameters. Then, the image enhancement processing unit 803 performs image enhancement processing using the selected parameters.

The preprocessing unit 802 performs preprocessing on the image acquired by the image acquisition unit 801, as described above. The following describes the case where the preprocessing is aberration correction for correcting aberrations caused by the optical characteristics specific to the imaging lens of the image capturing unit 705. In this case, the preprocessing unit 802 can perform preprocessing according to the imaging lens. That is, the strength of the preprocessing performed by the preprocessing unit 802 varies depending on the imaging lens of the image capturing unit 705. For example, when distortion caused by the optical characteristics of the imaging lens is larger, the amount of image variation caused by the preprocessing performed by the preprocessing unit 802 becomes larger.

In this modification, the image enhancement processing unit 803 can select a parameter of the machine learning model to be used in the image enhancement processing, from among a plurality of parameters. The image enhancement processing parameter suitable for the captured image that has undergone preprocessing by the preprocessing unit 802 is selected. Then, the image enhancement processing unit 803 performs the image enhancement processing on the captured image that has undergone the preprocessing, using the selected parameter. For example, the image enhancement processing unit 803 can select the parameter of the machine learning model that corresponds to the parameters of the preprocessing to be performed by the preprocessing unit 802. Furthermore, the image enhancement processing unit 803 can select the parameter of the machine learning model that corresponds to the amount of image variation caused by the preprocessing performed by the preprocessing unit 802. Additionally, the image enhancement processing unit 803 can select the parameter of the machine learning model that corresponds to the imaging lens of the image capturing unit 705.

The image enhancement processing unit 803 may select the parameter of the image enhancement processing with reference to the tables shown in FIGS. 12A and 12B. The table shown in FIG. 12B indicates a variation amount resulting from the preprocessing that corresponds to each of a plurality of imaging lenses. The image enhancement processing unit 803 can determine the variation amount resulting from the preprocessing with reference to the table shown in FIG. 12B. Then, the image enhancement processing unit 803 can select the parameter of the image enhancement processing that corresponds to the variation amount resulting from the preprocessing with reference to the table shown in FIG. 12A. Thus, in one embodiment, each parameter is associated with an imaging optical system. For example, for an image obtained using an imaging lens D, the preprocessing unit 802 performs preprocessing corresponding to the imaging lens D. In this case, since the amount of image variation resulting from the preprocessing is large, the variation amount “large” is associated with the imaging lens D. Therefore, the image enhancement processing unit 803 selects the parameter θ_{large} for the image enhancement processing that corresponds to the variation amount “large”.

As described above, when the amount of image variation resulting from the preprocessing is larger, the parameters of the image enhancement processing corresponding to this preprocessing are trained using an input image that has undergone the image correction processing according to the variable parameter selected from a larger range. For example, the parameter θ_{large} is trained using the input image that has undergone the image correction processing according to a wide range of variation patterns corresponding to the variation amount “large”. Such an input image has data characteristics close to those of a captured image after preprocessing when the variation amount resulting from the preprocessing is larger. In contrast, the parameter θₛₘₐₗₗ is trained using an input image that has undergone the image correction processing according to a narrow range of variation patterns corresponding to the variation amount “small”. Such an input image has data characteristics close to those of a captured image after preprocessing when the variation amount resulting from the preprocessing is smaller. Thus, the parameter selected by the image enhancement processing unit 803 is trained using an input image having data characteristics close to those of a captured image after preprocessing. Therefore, image enhancement processing using the selected parameter enables the acquisition of an image with higher quality.

Thus, according to this modification, more appropriate image enhancement processing can be performed based on the imaging optical system for use in image capture, or the preprocessing during inference corresponding to the imaging optical system. This modification is particularly effective when using interchangeable imaging lenses.

### Modification of Image Enhancement Processing

The image enhancement processing is not limited to demosaicing processing. The image enhancement processing may be, for example, noise removal processing or super-resolution processing. When the image enhancement processing is noise removal processing, noise addition processing can be performed as the inverse processing of the image enhancement processing. Furthermore, when the image enhancement processing is super-resolution processing, resolution reduction processing can be performed as the inverse process of the image enhancement processing. In the noise removal processing and the super-resolution processing, an input image and an output image have the same format. Even when performing image enhancement processing other than demosaicing processing, applying the above-described embodiment can improve the image quality obtained through the image enhancement processing.

The following describes the processing performed by the training apparatus 100 and the inference apparatus 700 when performing noise removal processing as the image enhancement processing. In this case, the formats of an input image and an output image with respect to a machine learning model for use in the image enhancement processing are the same. The image format may be, for example, a format of a single-channel mosaic image or a three-channel RGB image. In this modification, the inference apparatus 700 performs noise removal processing using the machine learning model on a single-channel mosaic image to output a noise-removed single-channel mosaic image. The following describes the specific processing in this modification.

The storage unit 104 stores a single-channel mosaic image as a GT image. This GT image is a GT image for noise removal processing.

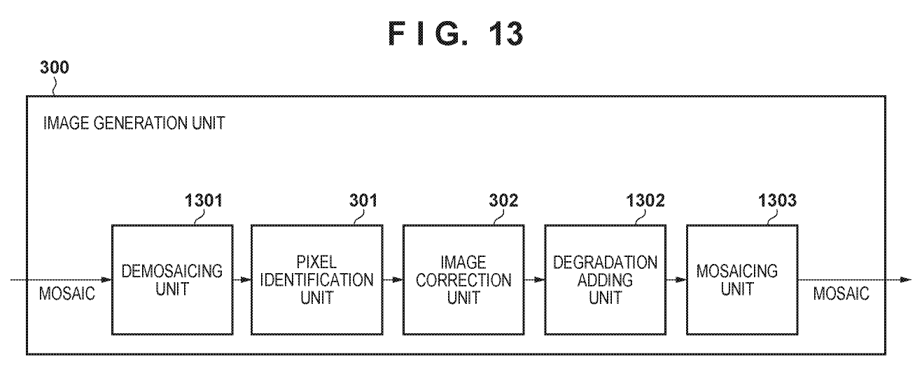

The image generation unit 300 generates an input image for training using the GT image acquired by the image acquisition unit 201. FIG. 13 shows an example of a functional configuration of the image generation unit 300 according to the modification. The image generation unit 300 includes a demosaicing unit 1301, the pixel identification unit 301, the image correction unit 302, a degradation adding unit 1302, and a mosaicing unit 1303. The functions of the pixel identification unit 301 and the image correction unit 302 are as already described.

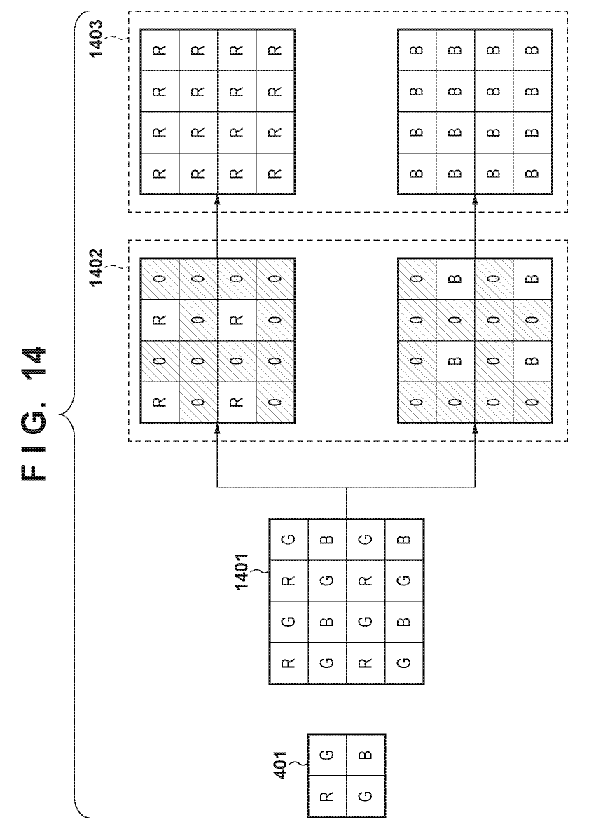

The demosaicing unit 1301 generates R-channel and B-channel images from the GT image that is a single-channel mosaic image. FIG. 14 is a diagram illustrating processing performed by the demosaicing unit 1301. The demosaicing unit 1301 generates thinned R-channel and B-channel images 1402 from a single-channel mosaic image 1401 according to the Bayer pattern color filter array 401. Then, the demosaicing unit 1301 generates an interpolated image 1403 by interpolating the thinned image 1402 so that it matches the size of the mosaic image 1401. The demosaicing unit 1301 may also generate a G-channel image through the demosaicing process.

The interpolated image 1403 generated in this manner includes the R-channel and B-channel images. The pixel identification unit 301 and the image correction unit 302 can perform the already described processing on the interpolated image 1403. In other words, the image correction unit 302 can perform image correction processing that corresponds to preprocessing such as aberration correction on the R-channel and B-channel images.

The degradation adding unit 1302 performs the inverse processing of the image enhancement processing on the image obtained through the image correction processing by the image correction unit 302. The degradation adding unit 1302 can add degradation corresponding to the image enhancement processing to the image. In this modification, the degradation adding unit 1302 adds noise to the image. For example, the degradation adding unit 1302 can add simulated noise to the image. Note that, when the image enhancement processing is super-resolution processing, the degradation adding unit 1302 can reduce the image resolution through downsampling. The degradation adding unit 1302 can perform this processing on each channel image. Note that the order of the image correction processing performed by the image correction unit 302 and the inverse processing of the image enhancement processing performed by the degradation adding unit 1302 is not particularly limited.

The mosaicing unit 1303 converts the image generated by the degradation adding unit 1302 into a single-channel mosaic image. The mosaicing unit 1303 can perform the same processing as the processing performed by the mosaicing unit 303.

Note that the demosaicing unit 1301 and the mosaicing unit 1303 are provided to handle a three-channel RGB image within the mosaicing unit 303. When the GT image is a three-channel RGB image, the demosaicing unit 1301 and the mosaicing unit 1303 are unnecessary.

The inference apparatus 700 can perform the preprocessing and the image enhancement processing as previously described, on a captured image, except that the image enhancement processing unit 803 uses a machine learning model for noise removal processing obtained by the above method.

As in this modification, regardless of the type of image enhancement processing, it is possible to make the data characteristics of input data for training closer to the data characteristics of a captured image to which the image enhancement processing during inference is to be applied. Therefore, it is possible to improve the accuracy of the image enhancement processing applied to the preprocessed image.

### Other Embodiments

The above-described embodiment has mainly described the case where warping processing is performed on an R-channel image and a B-channel image to align them with the G-channel image during aberration correction performed as preprocessing. In this case, the pixel identification unit 301 identifies pixels in the R-channel image and the B-channel image as image correction processing targets. However, the type of preprocessing is not particularly limited. For example, distortion aberration correction may be performed as the preprocessing. In this case, processing may be performed on each pixel of the images of the R channel, B channel, and G channel. Thus, it is not essential for the pixel identification unit 301 to identify the pixels serving as image correction processing targets. As another example of preprocessing, processing for removing resolution degradation caused by phenomena such as diffraction or low-pass filtering may be performed. In this case, the image correction processing may include, for example, edge enhancement processing or noise addition processing.

An embodiment of the present disclosure can improve the image quality obtained through image enhancement processing performed after preprocessing.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-036696, filed Mar. 7, 2025, which is hereby incorporated by reference herein in its entirety.

What is claimed is:

1. An information processing apparatus for training a machine learning model, comprising
one or more memories storing instructions; and
one or more processors that execute the instructions to:
acquire a ground truth (GT) image for use as GT data for training of the machine learning model that performs image enhancement processing for an image that has undergone preprocessing;
generate an input image that is used as input data for training of the machine learning model by performing processing associated with the preprocessing and inverse processing of the image enhancement processing on the GT image; and
update a parameter of the machine learning model stored in the one or more memories based on the input image and the GT image.

2. The information processing apparatus according to claim 1, wherein the one or more processors execute the instructions to update the parameter of the machine learning model based on an error between an image obtained by performing the image enhancement processing on the input image using the machine learning model, and the GT image.

3. The information processing apparatus according to claim 1, wherein the processing associated with the preprocessing is processing that introduces, into the input image characteristics that occur due to the preprocessing.

4. The information processing apparatus according to claim 1, wherein the one or more processors execute the instructions to:
generate a plurality of the input images by performing processing associated with the preprocessing according to different parameters and inverse processing of the image enhancement processing; and
update the parameter of the machine learning model based on each of the plurality of input images and on the GT image.

5. The information processing apparatus according to claim 1, wherein a parameter of the processing associated with the preprocessing is randomly determined.

6. The information processing apparatus according to claim 1, wherein a parameter of the processing associated with the preprocessing is determined within a predetermined range.

7. The information processing apparatus according to claim 1, wherein the one or more processors execute the instructions to:
generate a first input image for use as input data for training of the machine learning model by performing the processing associated with the preprocessing with a strength determined from a first range and the inverse processing of the image enhancement processing on the GT image;
generate a second input image for use as input data for training of the machine learning model by performing the processing associated with the preprocessing with a strength determined from a second range, which is different from the first range, and the inverse processing of the image enhancement processing on the GT image;
create a first parameter by updating the parameter of the machine learning model based on the first input image and the GT image; and
create a second parameter by updating the parameter of the machine learning model based on the second input image and the GT image.

8. The information processing apparatus according to claim 1, wherein the one or more processors execute the instructions to:
generate an additional input image for use as input data for training of the machine learning model by performing the inverse processing of the image enhancement processing without performing the processing associated with the preprocessing; and
update the parameter of the machine learning model based on each of the input image and the additional input image, and on the GT image.

9. The information processing apparatus according to claim 1, wherein the one or more processors execute the instructions to:
identify an area of the GT image to which the processing associated with the preprocessing is to be applied; and
apply the processing associated with the preprocessing to the identified area.

10. The information processing apparatus according to claim 9, wherein the one or more processors execute the instructions to identify the area to which the processing associated with the preprocessing is to be applied based on local contrast in the GT image.

11. The information processing apparatus according to claim 1, wherein the preprocessing is aberration correction processing, and
the processing associated with the preprocessing is geometric transformation processing, blur processing, or pixel value correction processing selectively performed on a high contrast area.

12. The information processing apparatus according to claim 1, wherein the preprocessing is aberration correction processing, and
the processing associated with the preprocessing for an image edge is stronger than the processing associated with the preprocessing for an image center.

13. The information processing apparatus according to claim 1, wherein the preprocessing is lateral chromatic aberration correction processing, and
the one or more processors execute the instructions to perform the processing associated with the preprocessing on an R channel and a B channel, selectively.

14. The information processing apparatus according to claim 1, wherein the image enhancement processing is demosaicing processing, noise removal processing, or super-resolution processing.

15. The information processing apparatus according to claim 1, wherein the image that has undergone preprocessing is a mosaic image according to a color filter array, the image enhancement processing is demosaicing processing, and the inverse processing of the image enhancement processing is mosaicing processing based on the color filter array.

16. An information processing apparatus comprising
one or more memories storing instructions and
one or more processors that execute the instructions to:
acquire an image;
perform preprocessing on the image; and
perform image enhancement processing on the preprocessed image using a machine learning model,
wherein the machine learning model is trained based on a GT image for use as GT data for training, and an input image for use as input data for training, the input image being obtained by performing processing associated with the preprocessing and inverse processing of the image enhancement processing on the GT image.

17. An information processing apparatus comprising one or more memories storing instructions and one or more processors that execute the instructions to:
acquire an image captured using an imaging optical system;
perform preprocessing according to the imaging optical system on the image; and
perform image enhancement processing on the preprocessed image using a machine learning model,
wherein a parameter of the machine learning model is selected, from a plurality of parameters, according to the imaging optical system.

18. A training method comprising:
acquiring a ground truth (GT) image for use as GT data for training of a machine learning model that performs image enhancement processing for an image that has undergone preprocessing;
generating an input image that is used as input data for training of the machine learning model by performing processing associated with the preprocessing and inverse processing of the image enhancement processing on the GT image; and
updating a parameter of the machine learning model based on the input image and the GT image.

19. An image processing method comprising:
acquiring an image captured using an imaging optical system;
performing preprocessing according to the imaging optical system on the image;
selecting a parameter of a machine learning model from a plurality of parameters, according to the imaging optical system; and
performing image enhancement processing on the preprocessed image using the machine learning model with the selected parameter,

20. A non-transitory computer-readable medium storing a program executable by a computer to perform a method comprising:
acquiring a ground truth (GT) image for use as GT data for training of a machine learning model that performs image enhancement processing for an image that has undergone preprocessing;
generating an input image that is used as input data for training of the machine learning model by performing processing associated with the preprocessing and inverse processing of the image enhancement processing on the GT image; and
updating a parameter of the machine learning model based on the input image and the GT image.
